(19) United States
(12) Patent Application Publication
(10) Pub. No.: US 2016/0044247 A1
(43) Pub. Date: Feb. 11, 2016

(54) ZOOM DUAL-APERTURE CAMERA WITH FOLDED LENS

(71) Applicant: Corephotonics Ltd., Tel-Aviv (IL)

(72) Inventors: Gal Shabtay, Tel Aviv (IL); Ephraim Goldenberg, Ashdod (IL); Gal Avivi, Haifa (IL); Gil Bachar, Tel-Aviv (IL)

(21) Appl. No.: 14/455,906

(22) Filed: Aug. 10, 2014

(51) Int. Cl. H04N 5/232; G02B 13/00

(52) U.S. Cl. CPC H04N 5/23296; G02B 13/0065; G02B 13/04

(57) ABSTRACT

Zoom digital cameras comprising a fixed-focus or auto-focus Wide sub-camera and a folded fixed-focus or auto-focus Tele sub-camera. The folded Tele sub-camera may be auto-focused by moving either its lens or a mirror inserted in an optical path between its lens and a respective image sensor. In some embodiments, a camera includes a third, Mid camera that has a field of view (FOV) intermediate to the FOVs of the Wide and Tele sub-cameras.

### FIELD

Embodiments disclosed herein relate in general to digital cameras and in particular to thin dual-aperture digital cameras with zoom and, optionally, auto-focus.

### BACKGROUND

In recent years, mobile devices such as cell-phones (“and in particular smartphones), tablets and laptops have become ubiquitous. Most of these devices include one or two compact cameras—a main rear-facing camera (i.e. a camera on the back side of the device, facing away from the user and often used for casual photography) and a secondary front-facing camera (i.e. a camera located on the front side of the device and often used for video conferencing).

Although relatively compact in nature, the design of most of these cameras is very similar to the traditional structure of a digital still camera, i.e. they comprise an optical component (or a train of several optical elements and a main aperture) placed on top of an image sensor. The optical component (also referred to as “optics”) refracts the incoming light rays and bends them to create an image of a scene on the sensor. The dimensions of these cameras are largely determined by the size of the sensor and by the height of the optics. These are usually tied together through the focal length (f) of the lens and its field of view (FOV)—a lens that has to image a certain FOV on a sensor of a certain size has a specific focal length. Keeping the FOV constant, the larger the sensor dimensions (e.g. in an X-Y plane), the larger the focal length and the optics height.

As the dimensions of mobile devices (and in particular the thickness of devices such as smartphones) shrink, the compact camera dimensions become more and more a limiting factor on the device thickness. Several approaches have been proposed to reduce the compact camera thickness in order to alleviate this constraint. Recently, multi-aperture systems have been proposed for this purpose. In such systems, instead of having one aperture with one train of optical elements, the camera is divided into several apertures, each with dedicated optical elements, all sharing a similar field of view. Hereinafter, each such aperture, together with the optics and the sensor area on which the image is formed, is defined as a “sub-camera”. Images from the sub-cameras are fused together to create a single output image. Typically, in multi-aperture camera designs, each sub-camera creates a smaller image on the image sensor compared with the image created by a reference single-aperture camera. Therefore, the height of each sub-camera can be smaller than the height of a single-aperture camera, reducing the total height of the camera and allowing for slimmer designs of mobile devices.

Dual-aperture zoom cameras in which one sub-camera has a wide FOV (“Wide sub-camera”) and the other has a narrow FOV (“Tele sub-camera”) are known. A major problem with dual-aperture zoom cameras relates to their height. There is a large difference in the height (also known as “total track length” or “TTL”) of the Tele (“T”) and Wide (“W”) sub-cameras. The TTL is defined as the maximal distance between the object-side surface of a first lens element and a camera image sensor plane. In most miniature lenses, the TTL is larger than the lens effective focal length (EFL). A typical TTL/EFL ratio for a given lens (or lens assembly) is around 1.3. In a single-aperture smartphone camera, EFL is typically 3.5 mm, leading to a FOV of 70-80°. Assuming one wishes to achieve a dual-aperture X2 optical zoom in a smartphone, it would be natural to use EFL_{W}=3.5 mm and EFL_{T}=2×EFL_{W}=7 mm However, without spatial restrictions, the Wide lens will have an EFL_{W}=3.5 mm and a TTL_{W} of 3.5×1.3=4.55 mm, while the Tele lens will have EFL_{T}=7 mm and TTL_{T} of 7×1.3=9.1 mm The incorporation of a 9.1 mm lens in a smartphone camera would lead to a camera height of around 10 mm, which is unacceptable for many smartphone makers.

FIG. 1 shows schematically an embodiment of a dual-aperture zoom camera with auto-focus (AF) and numbered 100, in (a) a general isomeric view, and (b) a sectioned isomeric view. Such a camera is disclosed exemplarily in co-invented and co-owned PCT patent application PCT/IB2014/062180 titled “Dual-aperture zoom digital camera”. Camera 100 comprises two sub-cameras, labeled 102 and 104, each sub-camera having its own optics. Thus, sub-camera 102 includes an optics bloc 106 with an aperture 108 and an optical lens module 110, as well as a sensor 112. Similarly, sub-camera 104 includes an optics bloc 114 with an aperture 116 and an optical lens module 118, as well as a sensor 120. Each optical lens module may include several lens elements as well as an Infra-Red (IR) filter 122a and 122b. In some embodiments, some or all of the lens elements belonging to different apertures may be formed on the same substrate. The two sub-cameras are positioned next to each other, with a small baseline 124 between the center of the two apertures 108 and 116. Each sub-camera further includes an AF mechanism, respectively 126 and 128. Camera 100 is “thin” as expressed by TTL/EFL for each sub-camera. Typically, TTL_{W}/EFL_{W}>1.1 and TTL_{T}/EFL_{T}<1.0. Practically in a camera such as camera 100, TTL_{T}/EFL_{T}>0.85.

The zoom range in camera 100 is about X2. It would be advantageous to further increase this range. However, this requires increasing further the Tele lens EFL (EFL_{T}), which will cause an increase in the camera height. An increase of EFL_{T} to exemplarily 12 mm will result in an undesirable camera height of for example 0.85×12+0.9=11.1 mm.

### SUMMARY

In some embodiments there are provided zoom digital cameras comprising: a Wide sub-camera that includes a Wide lens and a Wide image sensor, the Wide lens having a Wide lens symmetry axis along a first optical path between an object and the Wide image sensor, the Wide sub-camera configured to provide a Wide image; a Tele sub-camera that includes a Tele lens and a Tele image sensor, the Tele lens having a Tele lens symmetry axis along a second optical path, the Tele lens symmetry axis positioned substantially perpendicular to the Wide lens symmetry axis, the Tele camera configured to provide a Tele image; a first mirror having a first mirror symmetry axis inclined substantially at 45 degrees to both the Wide lens symmetry axis and the Tele lens symmetry axis and operative to provide a folded optical path between the object and the Tele image sensor; and a processor for processing the Tele image and the Wide image into an output image. The Wide lens has a Wide field of view (FOV) and the Tele lens has a Tele FOV narrower than the Wide FOV.

In an embodiment, the camera further comprises a Tele AF mechanism that is operative to move the Tele lens along the Tele symmetry axis and the Tele image sensor lies in a plane substantially perpendicular to a plane that includes the Tele lens symmetry axis.

In an embodiment, a camera further comprises a second mirror positioned between the Tele lens and the Tele image sensor, the second mirror having a second mirror symmetry axis inclined substantially at 45 degrees to the Tele lens symmetry axis. In such a camera, a Tele AF mechanism may be operative to move the second mirror along its symmetry axis, along the optical axis, or along a direction perpendicular to the Tele image sensor. Alternatively, the Tele AF mechanism may be operative to move the Tele lens along the Tele lens symmetry axis. In some embodiments with a moving second mirror the Tele image sensor lies in a plane substantially parallel to a plane that includes the Tele lens symmetry axis. In an embodiment, the Wide and Tele image sensors may be mounted on a single printed circuit board.

In some camera embodiments, a camera further comprises a Mid sub-camera that includes a Mid lens with a Mid FOV intermediate to the Wide and Tele FOVs and a Mid image sensor, the Mid lens having a Mid lens symmetry axis substantially parallel to the Wide lens symmetry axis, the Mid camera having configured to provide a Mid image. In such “three sub-camera” embodiments, Tele auto-focus may be achieved by moving the Tele lens or a second mirror as described above.

### BRIEF DESCRIPTION OF THE DRAWINGS

Non-limiting examples of embodiments disclosed herein are described below with reference to figures attached hereto that are listed following this paragraph. The drawings and descriptions are meant to illuminate and clarify embodiments disclosed herein, and should not be considered limiting in any way. Like elements in different drawings are indicated by the same numerals.

FIG. 1 shows schematically the design of a known dual-aperture camera with zoom and AF;

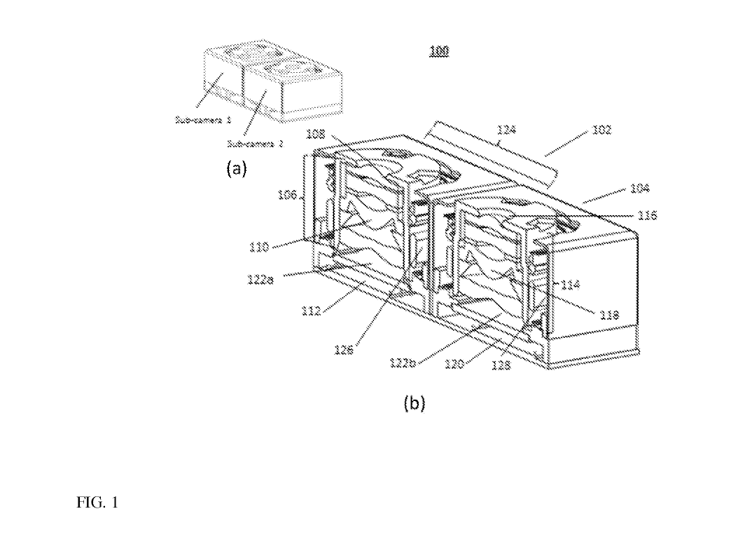

FIG. 2 shows schematically an embodiment of a zoom and auto-focus dual-aperture camera with folded tele lens disclosed herein in (a) a general isomeric view, and (b) a side view;

FIG. 3 shows schematically of another embodiment of a zoom and auto-focus dual-aperture camera with folded tele lens disclosed herein in (a) a general isomeric view, and (b) a side view;

FIG. 4 shows schematically of yet another embodiment of a zoom and auto-focus dual-aperture camera with folded tele lens disclosed herein in (a) a general isomeric view, and (b) a side view;

FIG. 5 shows schematically details of the auto-focus mechanism for moving the second minor in the embodiment of FIG. 4 in (a) a general isomeric view, and (b) a cross sectional view through section A-A.

FIG. 6 shows schematically an embodiment of a zoom and auto-focus triple-aperture camera with folded tele lens disclosed herein in (a) a general isomeric view, and (b) a side view.

### DETAILED DESCRIPTION

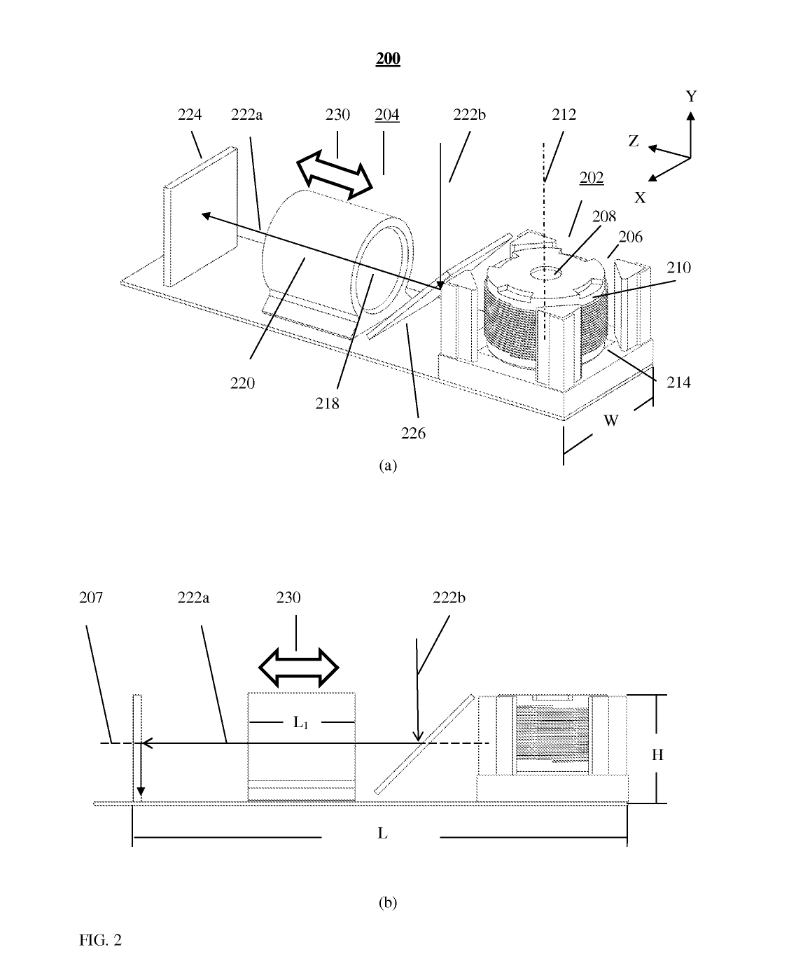

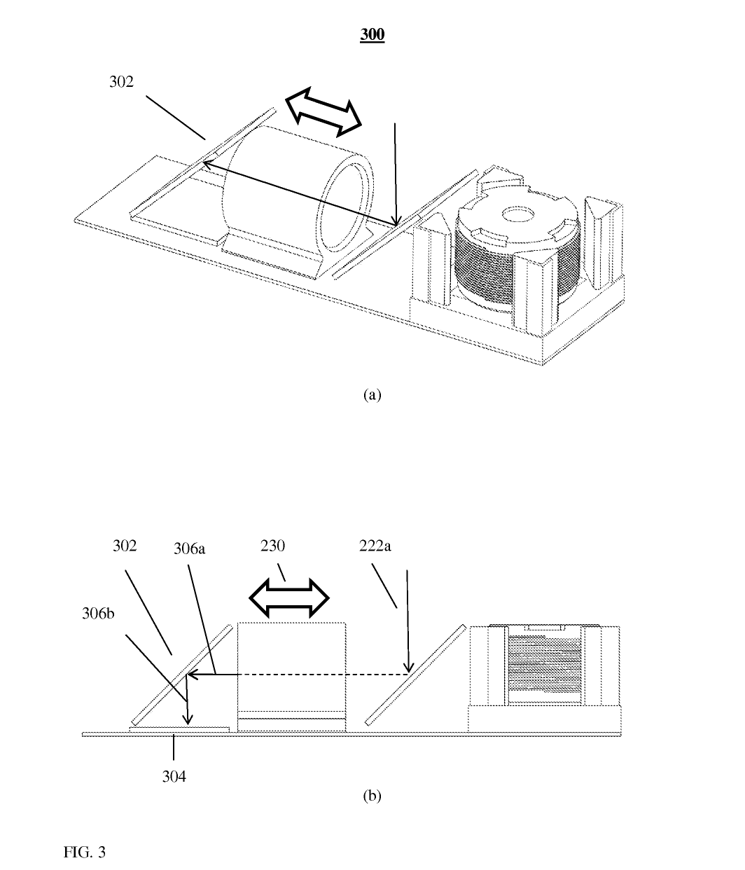

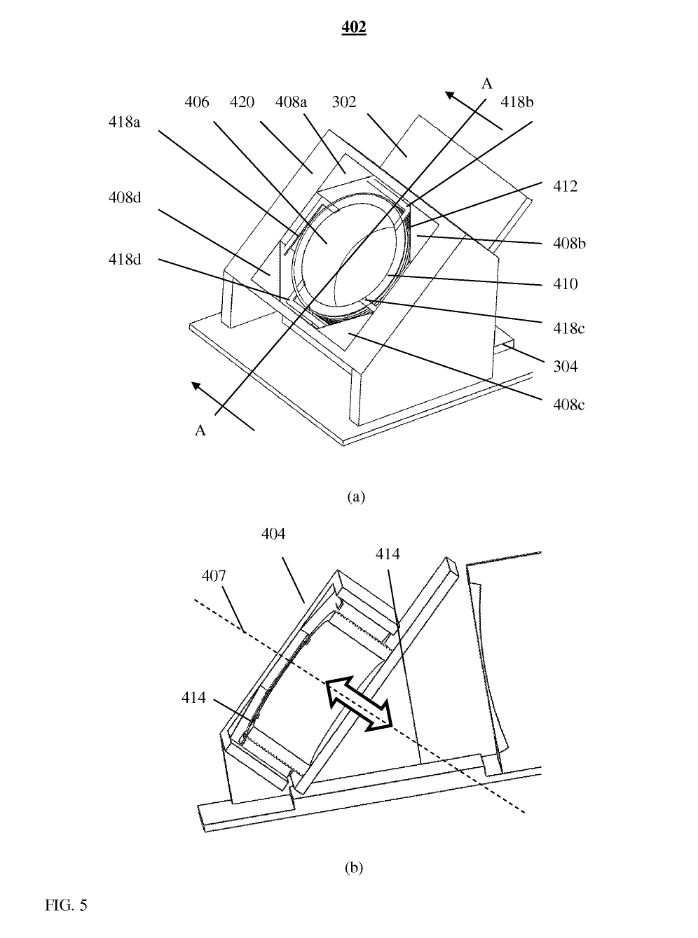

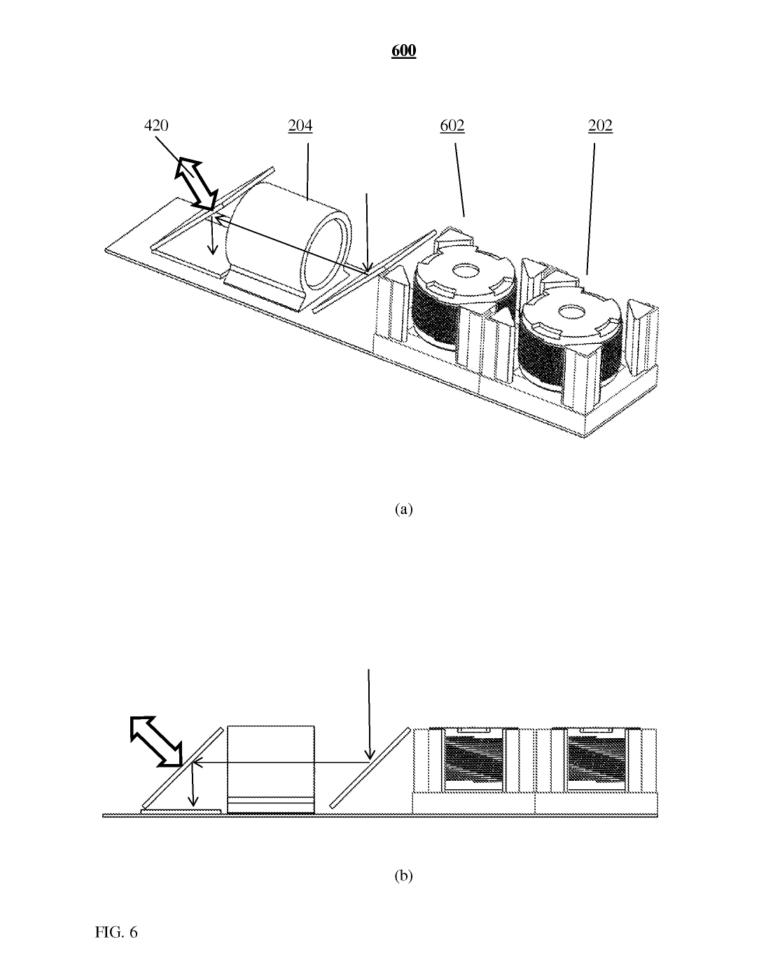

FIG. 2 shows schematically an embodiment of a zoom and auto-focus dual-aperture camera with folded Tele lens disclosed herein and numbered 200 in (a) a general isomeric view and (b) a sectioned isomeric view. The isometric view is shown related to a XYZ coordinate system, which also holds in FIGS. 3 and 6. Camera 200 comprises two sub-cameras, a regular Wide sub-camera 202 and a Tele sub-camera 204. Wide camera 202 includes a Wide optics bloc with a respective aperture 208 and an optical lens module 210 with a symmetry (and optical) axis 212 in the Y direction, as well as a Wide image sensor 214. Tele camera 204 includes a Tele optics bloc with a respective aperture 218 and an optical lens module 220 with a symmetry (and optical) axis 221, as well as a Tele image sensor 224. Camera 200 further comprises a first flat reflecting element (exemplarily a mirror) 226 inserted in a “Tele” optical path from an object (not shown) through the Tele lens module (or simply “Tele lens”) to the Tele sensor marked by arrows 222a and 222b. Hereinafter the reflective element is referred to simply as “mirror”. The Wide image sensor lies in the X-Z plane, while the Tele image sensor lies a X-Y plane perpendicular to the Tele lens optical axis. Mirror 226 is inclined at 45° to the Tele lens optical axis (arrow 222a) and to arrow 222b. The Tele optical path is thus “folded”. Hereinafter, a Tele lens having a folded optical path passing there-through is referred to as “folded Tele lens” and a Tele sub-camera with such folded lens is referred to as a “folded Tele sub-camera”. Both Wide and Tele sub-cameras may be FF or AF. An AF mechanism for the Wide camera is indicated generally by numeral 206, and in an embodiment it can be similar to the mechanism shown in FIG. 5. If an AF mechanism is included in the Tele camera, it is applied such that the auto-focus movement is transferred from the Z axis to the X axis is coupled to and operative to move the Tele lens along the X axis in a direction shown by an arrow 230, i.e. parallel to its optical axis 222a The Tele lens movement range may be exemplarily between 100-500 μm. Camera 200 further includes a processor (not shown) for processing the Tele image and the Wide image into an output image.

Camera 200 may have exemplary dimensions and/or parameters as follows: a camera height H between about 5-12 mm, a camera length L between about 15-30 mm, Tele sensor length/width (in the sensor flat plane) between about 4-8 mm, a Wide sub-camera effective focal length (EFL) between about 2.5-7 mm and a F-number (F#) between about 2-3, and a Tele sub-camera EFL between about 7-15 mm and F# between about 2-3. A length L₁ of the Tele lens barrel ranges between about 3-10 mm.

The folding of the Tele lens in camera 200 (as well as in cameras 300-600 below) enables use of a Tele lens with exemplarily an EFL_{T} of 12 mm to result in a much lower camera height of about 7 mm.

FIG. 3 shows schematically yet another embodiment of a zoom and auto-focus dual-aperture camera with folded Tele lens disclosed herein and numbered 300 in (a) a general isomeric view and (b) a sectioned isomeric view. Camera 300 is substantially identical with camera 200, except that camera 300 includes a second mirror 302 inserted in the optical path between the Tele lens and a Tele sensor 304, the path marked here by arrows 306a and 306b. In addition and unlike in camera 200 (but as in camera 100), Tele sensor 304 lies in the X-Z plane. In an embodiment, the Wide and Tele sensors may be placed on the same printed circuit board. Both mirrors are inclined at 45° to the Tele lens optical axis 222a. As in camera 200, the Wide sub-camera may be FF or AF while the Tele lens may be FF or AF. As in camera 300, an AF mechanism (not shown) is coupled to and operative to move the Tele lens along the X axis in a direction shown by an arrow 230, i.e. parallel to its optical axis 222a. Camera 300 may have exemplarily the same dimensions and/or parameters as camera 200 or larger by 5-10 mm along the Z axis. Camera 300 requires that the Tele lens is designed such that its back focal length (BFL), i.e. the distance along the optical path from the left hand side of the Tele lens barrel to the mirror and from there to the Tele image sensor, is large enough to enable the inclusion of the second mirror. In addition, the folded Tele geometry in camera 300 allows direct mounting of the Wide and Tele images sensors on a single printed circuit board.

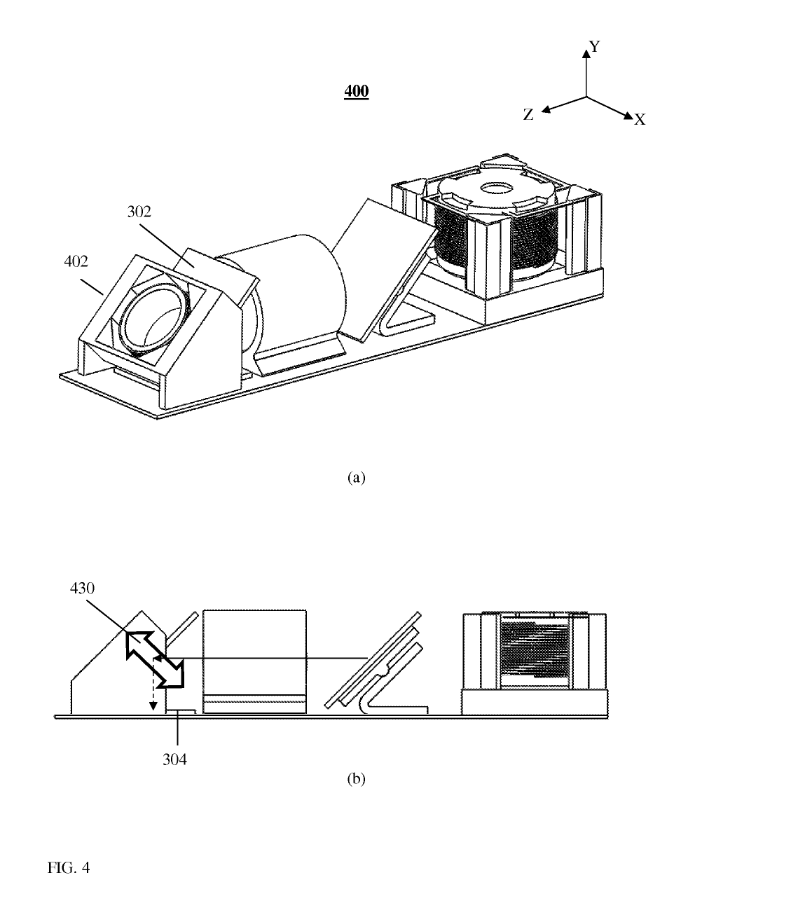

FIG. 4 shows schematically an embodiment of a zoom and auto-focus dual-aperture camera with folded Tele lens disclosed herein and numbered 400 in (a) a general isomeric view and (b) a sectioned isomeric view. Camera 400 is substantially identical with camera 300, except that the Tele sub-camera is auto-focused by means of moving the second mirror using an AF mechanism (see FIG. 5) 402 coupled thereto. Mechanism 402 moves second mirror 302 in a direction perpendicular to its flat plane (i.e. at 45° to the X-Y and X-Z planes) shown by an arrow 430, The mirror movement range may be exemplarily between 100-500 μm. Alternatively, the second mirror can be moved in other directions to focus the Tele image that is captured by the Tele sensor, for example, along the Z axis or the Y axis.

FIG. 5 shows schematically details of mechanism 402 in (a) a general isomeric view, and (b) a cross sectional view through section A-A. Mechanism 402 includes an electromagnetic actuator comprising a stationary member 404 and a moving member 406. Stationary member 404 includes four permanent magnets 408a-d. Moving member 406, shown here generally to have a cylindrical shape with a symmetry axis 407 includes a core 410 surrounded at least partially by a coil 412. Moving member 406 is mechanically coupled at one end 414 to mirror 302 and at an opposite end 416 to four springs 418a-d, which in turn are rigidly coupled to a stationary frame 420. The number of springs shown is exemplary, and fewer (e.g. one) or more springs than four can be used. In use, a current passing through coil 412 leads to a magnetic force that causes moving member 406 and minor 302 to move along symmetry axis 407.

FIG. 6 shows schematically an embodiment of a zoom and auto-focus triple-aperture camera with folded tele lens disclosed herein and numbered 600 in (a) a general isomeric view, and (b) a side view. Camera 600 includes exemplarily all the elements and functionalities of camera 400. That is, camera 600 includes a folded Tele lens and a second minor. As shown, Tele auto-focus is achieved by moving the second minor. For simplicity, the AF mechanism (similar to that in FIGS. 4 and 5) is not shown. However, in another embodiment, Tele auto-focus may be achieved by moving the Tele lens, like in camera 300. In addition to the elements of 400, camera 600 further includes a second Tele (referred to as “Mid” or “M”) sub-camera 602. Mid sub-camera 602 has an EFL_{M} and a FOV_{M} intermediate to those of the Wide and Tele sub-cameras, for example EFL_{M} of 7 mm with FOV_{M} of 45°. In use, an output FOV of camera 600 is defined by a zoom factor ZF. For example, in zoom-in up to a ZF=ZF_{M} the camera output is the same as the output of a dual-aperture zoom camera with only Wide and Mid sub-cameras, where the Mid sub camera replaces the Tele sub-camera. When zooming in from ZF_{M} to ZF_{T} the camera output is the same as the output of a dual-aperture zoom camera with only Mid and Tele sub-cameras, where the Mid sub-camera replaces the Wide sub-camera. This provides a continuous zoom experience. Details describing such dual-aperture zoom camera operation may be found in co-invented and co-assigned PCT patent applications PCT/IB2014/062180, titled “Dual aperture zoom digital camera” and PCT/IB2014/062854, titled “Thin dual-aperture zoom digital camera”.

While this disclosure has been described in terms of certain embodiments and generally associated methods, alterations and permutations of the embodiments and methods will be apparent to those skilled in the art. The disclosure is to be understood as not limited by the specific embodiments described herein, but only by the scope of the appended claims.

All references mentioned in this specification are herein incorporated in their entirety by reference into the specification, to the same extent as if each individual reference was specifically and individually indicated to be incorporated herein by reference. In addition, citation or identification of any reference in this application shall not be construed as an admission that such reference is available as prior art to the present application.

What is claimed is:

1. A zoom digital camera comprising:
a) a Wide sub-camera that includes a Wide lens and a Wide image sensor, the Wide lens having a Wide lens symmetry axis along a first optical path between an object and the Wide image sensor, the Wide sub-camera configured to provide a Wide image;
b) a Tele sub-camera that includes a Tele lens and a Tele image sensor, the Tele lens having a Tele lens symmetry axis along a second optical path, the Tele lens symmetry axis positioned substantially perpendicular to the Wide lens symmetry axis, the Tele camera configured to provide a Tele image;
c) a first mirror having a first mirror symmetry axis inclined substantially at 45 degrees to both the Wide lens symmetry axis and the Tele lens symmetry axis and operative to provide a folded optical path between the object and the Tele image sensor; and
d) a processor for processing the Tele image and the Wide image into an output image.

2. The camera of claim 1, wherein the Tele image sensor lies in a plane substantially perpendicular to a plane that includes the Tele lens symmetry axis.

3. The camera of claim 2, further comprising a Tele AF mechanism that is operative to move the Tele lens along the Tele symmetry axis.

4. The camera of claim 1, further comprising a second mirror positioned between the Tele lens and the Tele image sensor, the second mirror having a second mirror symmetry axis inclined substantially at 45 degrees to the Tele lens symmetry axis, wherein the Tele image sensor lies in a plane substantially parallel to a plane that includes the Tele lens symmetry axis.

5. The camera of claim 4, further comprising a Tele AF mechanism that is operative to move the second mirror.

6. The camera of claim 5, wherein the Wide and Tele image sensors are mounted on a single printed circuit board.

7. The camera of claim 4, further comprising a Tele AF mechanism that is operative to move the Tele lens along the Tele lens symmetry axis.

8. The camera of claim 7, wherein the Wide and Tele image sensors are mounted on a single printed circuit board.

9. The digital camera of claim 1, wherein the Wide lens has a first field of view (FOV) and wherein the Tele lens has a Tele FOV narrower than the Wide FOV, the camera further comprising a Mid sub-camera that includes a Mid lens with a FOV intermediate to the first and Tele FOVs and a Mid image sensor, the Mid lens having a Mid lens symmetry axis substantially parallel to the Wide lens symmetry axis, the Mid camera having configured to provide a Mid image.

10. The camera of claim 9, wherein the Tele image sensor lies in a plane substantially perpendicular to a plane that includes the Tele lens symmetry axis.

11. The camera of claim 10, further comprising a Tele AF mechanism that is operative to move the Tele lens along the Tele symmetry axis.

12. The camera of claim 9, further comprising a second mirror positioned between the Tele lens and the Tele image sensor, the second mirror having a second minor symmetry axis inclined substantially at 45 degrees to the Tele lens symmetry axis, wherein the Tele image sensor lies in a plane substantially parallel to a plane that includes the Tele lens symmetry axis.

13. The camera of claim 12, further comprising a Tele AF mechanism that is operative to move the second mirror.

14. The camera of claim 13, wherein the Wide, Mid and Tele image sensors are mounted on a single printed circuit board.

15. The camera of claim 12, further comprising a Tele AF mechanism that is operative to move the Tele lens along the Tele lens symmetry axis.

16. The camera of claim 15, wherein the Wide, Mid and Tele image sensors are mounted on a single printed circuit board.

17. The camera of claim 9, wherein the processor is configured to use a zoom factor (ZF) to determine a respective output field of view (FOV).

18. The camera of claim 17, wherein processor is configured to output an output image formed by using Wide and Mid images for a ZF that sets a FOV between an FOV of the Wide image and the FOV of the Mid image.

19. The camera of claim 17, wherein processor is configured to output an output image formed by using Mid and Tele images for a ZF that sets a FOV between the FOV of the Mid image and the FOV of the Tele image.
